(19) United States
(12) Patent Application Publication
(10) Pub. No.: US 2007/0079332 A1
(43) Pub. Date: Apr. 5, 2007

(54) Network branded recorded programs

(75) Inventor: Elizabeth Rose McEnroe, Palo Alto, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/241,891

(22) Filed: Sep. 30, 2005

(51) Int. Cl. H04N 5/445; G06F 3/00; G06F 13/00

(52) U.S. Cl. 725/46; 725/58; 725/45

(57) ABSTRACT

Network branded recorded programs is described. In an embodiment programs recorded from television are associated with their respective television networks, and a recorded program directory is generated. The recorded program directory includes a list of television networks, and a list of programs recorded from television that are respectively associated with each of the television networks. In another embodiment, a television-based client device is described. The device includes a data store to store programs recorded from television networks, and also includes a program guide application to categorize each program according to an associated television network. The device can also generate a recorded program directory that includes a list of the television networks and a list of programs associated with each of the respective television networks. The program guide application can also generate the list of television networks and the list of programs as interactive on-screen network menus.

### BACKGROUND

During the past several years, television viewing habits have been rapidly changing in response to advances in technology, and to an increased availability of viewing content. Until recently, television programming in most countries was dominated by a few broadcast networks, but with improvements in technology, many more television networks are now distributing content. Many of these new television networks provide specialized content that is intended to cater to the interests of a specific viewing audience.

In addition to the increased number of television networks, the use of digital video recorders has also changed the way many people view television. A digital video recorder (DVR), also called a personal video recorder (PVR), is an electronic device that records television programs to a hard disc and/or other data store in a digital format. The digital video recorder allows a user to view a recorded program at a later time, and in many cases allows a user to pause “live television”, to replay interesting scenes, to skip advertising, and/or to otherwise manipulate the recorded television program.

Current digital video recording devices typically provide a means for sorting and locating recorded television programs by time and date. Although such sorting is helpful, it can be difficult for a user to navigate and locate recorded programs using the limited means currently available.

### SUMMARY

This summary is provided to introduce simplified concepts of network branded recorded programs that are further described below in the Detailed Description. This summary is not intended to identify essential features of the claimed subject matter, nor is it intended for use in determining the scope of the claimed subject matter.

In one embodiment of network branded recorded programs, a television-based client device is described. The television-based client device includes a data store that stores programs recorded from television, and also includes a program guide application. The program guide application can categorize each program according to an associated television network, and generate a recorded program directory that includes a list of the television networks and a list of programs associated with each of the respective television networks. The program guide application can also generate the list of television networks as an interactive on-screen network menu from which a user can select a television network, and generate the list of the programs as a selectable program menu from which a user can select a program.

In another embodiment of network branded recorded programs, programs recorded from television are associated with their respective television network, and a recorded program directory is generated. The recorded program directory includes a list of television networks, and also includes a list of programs recorded from television that are respectively associated with each television network in the list of television networks.

### BRIEF DESCRIPTION OF THE DRAWINGS

The same numbers are used throughout the drawings to reference like features and components.

FIG. 1 illustrates an exemplary television-based system in which embodiments of network branded recorded programs can be implemented.

FIG. 2 illustrates an exemplary television-based system in which embodiments of network branded recorded programs can be implemented.

FIG. 3 illustrates an exemplary method for network branded recorded programs.

FIG. 4 illustrates various components of an exemplary client device in a television-based system, and in which embodiments of network branded recorded programs can be implemented.

FIG. 5 illustrates various devices and components in an exemplary entertainment and information system in which embodiments of network branded recorded programs can be implemented.

### DETAILED DESCRIPTION

Network branded recorded programs is described in which embodiments provide that programs recorded from television are associated with the respective networks from which the programs are recorded, and a recorded program directory is generated. The recorded program directory includes a list of television networks, and also includes a list of programs recorded from television that are respectively associated with each television network in the list of networks. With network branded recorded programs, the recorded programs can be associated with their respective networks for increased brand association, and a user can be provided with a convenient option of searching the recorded programs by network.

While aspects of the described systems and methods for network branded recorded programs can be implemented in any number of different computing systems, environments, television-based entertainment systems, and/or configurations, embodiments of network branded recorded programs are described in the context of the following exemplary system architectures.

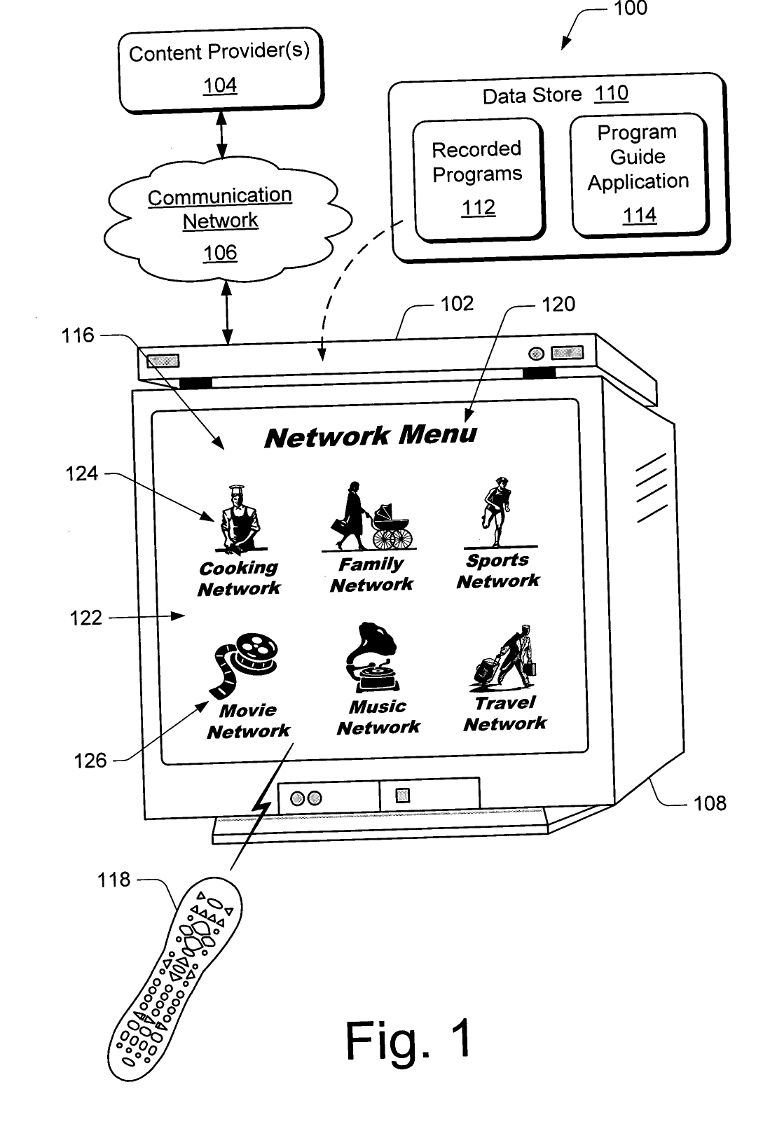

FIG. 1 illustrates an exemplary television-based system 100 in which embodiments of network branded recorded programs can be implemented. The television-based system 100 includes an exemplary television-based client device 102 configured for data communication with any number of content provider(s) 104 via a communication network 106. The television-based client device 102 receives content such as television programs from various television networks, and receives program guide data, advertising content, and other various forms of media content and the like from content server(s) of the content provider(s) 104 via the communication network 106.

The television-based client device 102 is connected to a display device 108 (e.g., a television, LCD display, audio/video rendering system, or the like). The television-based client device 102 can be implemented in any number of embodiments, such as a set-top box, a digital video recorder (DVR) and playback system, a personal video recorder (PVR), an appliance device, a gaming system, any combination thereof, and as any other type of client device that may be implemented in a television-based entertainment and information system.

Alternatively, the television-based client device 102 can be implemented as part of, or within, the display device 108.

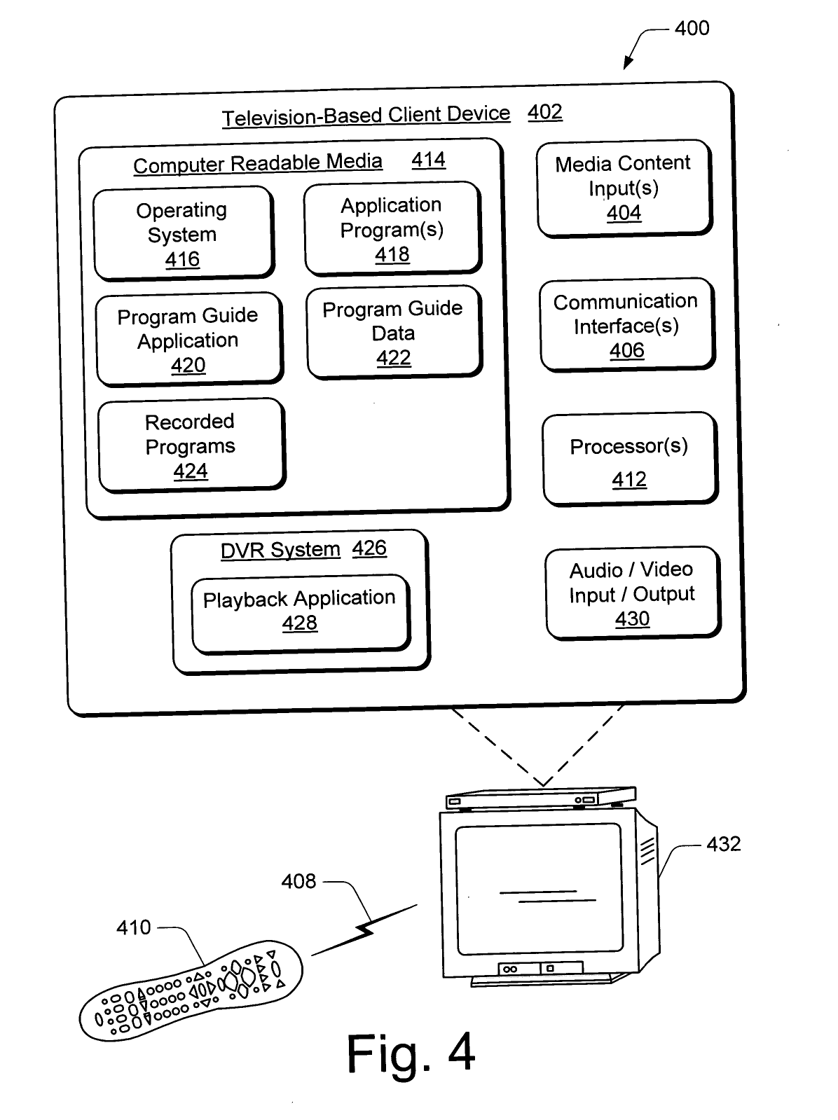

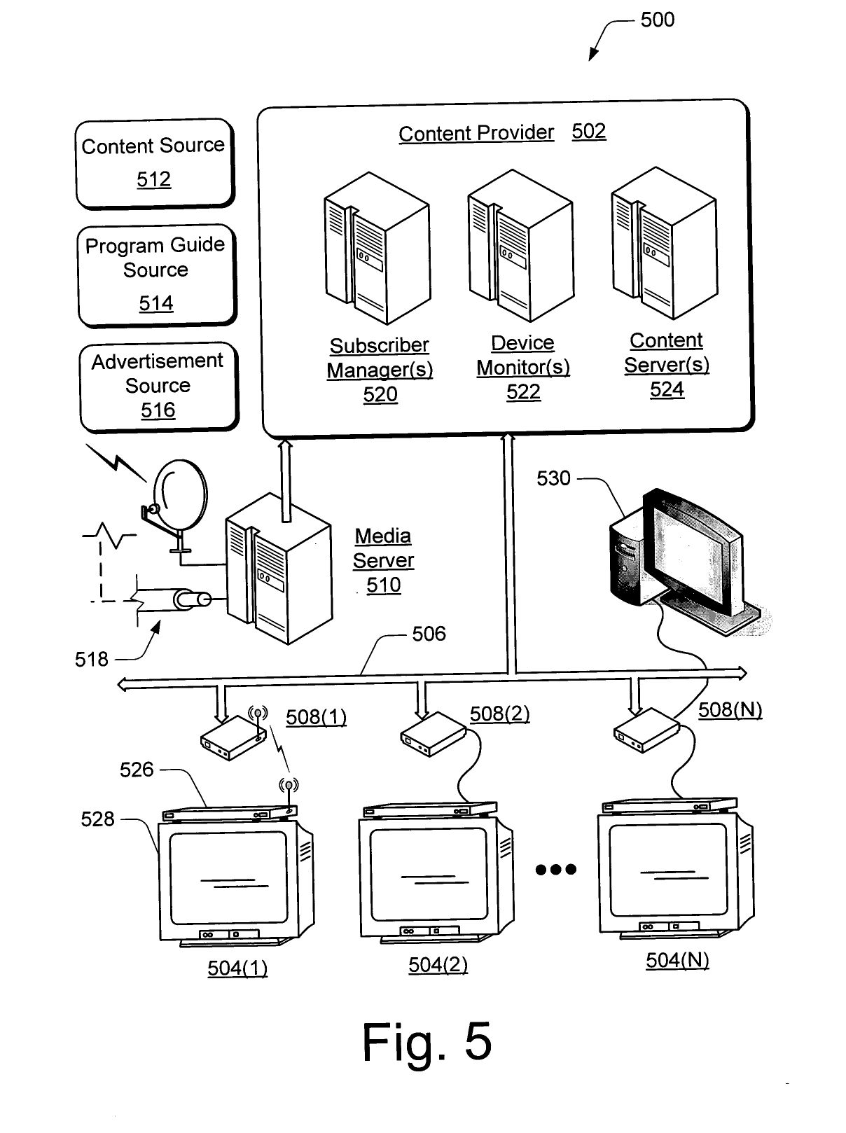

In an embodiment, the television-based client device 102 can be implemented with any one or combination of the components described with reference to television-based client device 402 shown in. FIG. 4. The television-based client device 102 is an example of client device 402 shown in FIG. 4. Further, any combination of the components described with reference to the television-based system 100 can be implemented in the exemplary television-based system 500 that includes examples of both a network-based content provider and television-based client devices as described with reference to FIG. 5.

The television-based client device 102 includes a data store 110 configured to store programs 112 recorded from television networks, and also includes a program guide application 114. The data store 110 can be any kind of computer readable media that provides data storage mechanisms to store various information and/or data such as software applications and any other types of information and data related to operational aspects of the client device 102. Examples of such computer readable media are described below with reference to client device 402 shown in FIG. 4.

In various embodiments of network branded recorded programs, the program guide application 114 can: (1) categorize each recorded program 112 according to an associated television network from which a program was recorded or obtained; (2) generate a recorded program directory that includes a list of the television networks and a list of recorded program(s) 112 associated with each of the respective television networks; (3) generate the list of television networks as an interactive on-screen network menu from which a user can select a television network; and (4) generate the list of the recorded programs as a selectable program menu from which a user can select a program that has been recorded (i.e., a recorded program).

The television-based client device 102 provides the user with a convenient option that allows the user to search the recorded television programs 112 by network (i.e., an associated network from which a program was recorded). This option can be provided as interactive on-screen menus 116 that can be easily navigated using a remote control 118. For example, once the user has selected to search the recorded programs 112 by network, an interactive on-screen network menu 120 can be provided. The interactive on-screen network menu 120 is one type of interactive on-screen menu 116, and includes a list of television networks (shown as the interactive on-screen menus 122) to facilitate the user's selection of a network of interest. The list of television networks 122 is generated by the program guide application 114 of the television-based client device 102, and is displayed in the interactive on-screen network menu 120. The user can navigate the interactive on-screen network menu 120, and can select a network of interest from the on-screen network menu 120, using the remote control device 118.

In the example shown in FIG. 1, the interactive on-screen network menu 120 includes six different television networks that include the “Cooking Network”, the “Family Network”, the “Sports Network”, the “Movie Network”, the “Music Network”, and the “Travel Network”. Each of these networks represents a different television network that is associated with television programs that have been recorded by the user.

In one implementation the list of television networks 122 includes network logos that each represents a television network in the list of networks 122.

For example, the “Cooking Network” has an associated logo 124 that is a representation of a chef. The “Movie Network” is represented by a logo 126 that is a drawing of a movie reel to represent “movies”. However, the list of television networks 122 can be displayed in many different ways. For example, the television networks can be represented by text only (e.g., the written names of the networks without accompanying logos), by the network logos only (without accompanying text), and/or by the network logos with accompanying text (as shown in FIG. 1).

The user can navigate the list of television networks 122 using the interactive on-screen network menu 120. For example, the user can select the “Cooking Network” 124 from the exemplary interactive on-screen network menu 120. In one implementation, when the user uses the interactive on-screen network menu 120 to focus on a particular network logo, any other logos will fade back, so that the particular network logo is emphasized. In addition, a background graphic associated with the particular network logo can be displayed in the interactive on-screen network menu 120.

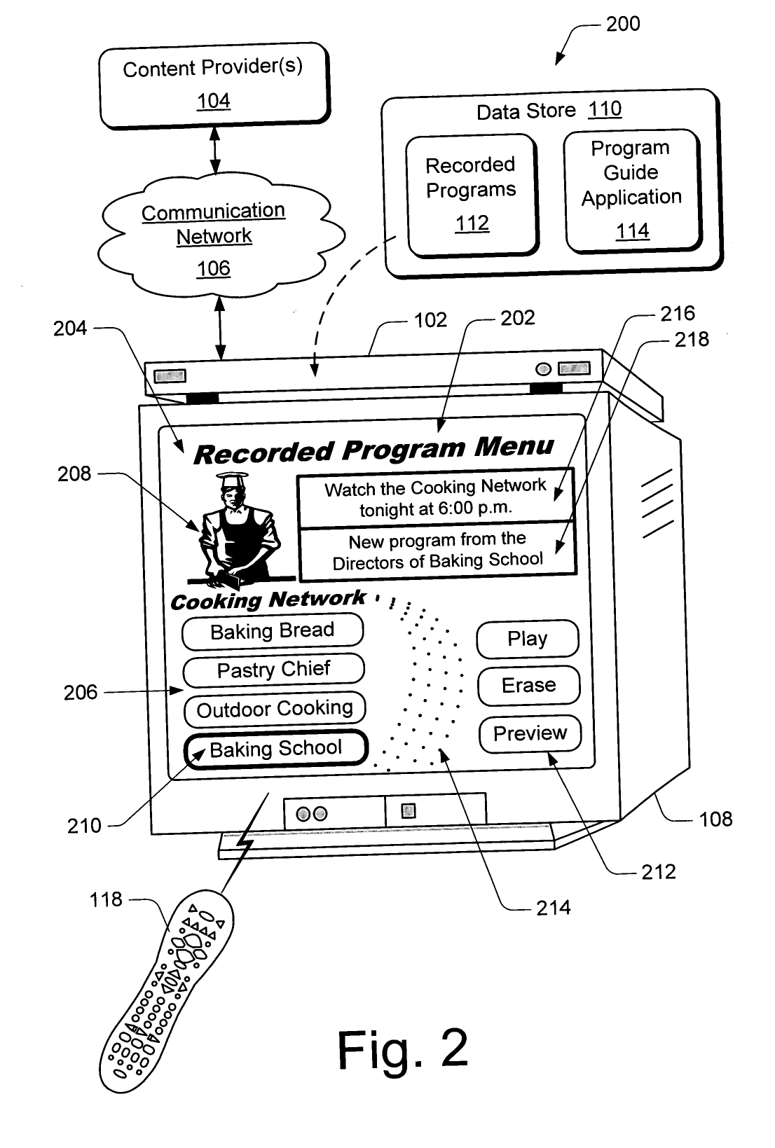

FIG. 2 illustrates an exemplary television-based system 200 in which embodiments of network branded recorded programs can be implemented. As described above with reference to FIG. 1, the exemplary television-based client device 102 communicates with any number of content provider(s) 104 via a communication network 106, and is connected to the display device 108. Additionally, the remote control device 118 can be used to navigate the interactive on-screen menus 116.

When a television network of interest (e.g., the “Cooking Network” 124 shown in FIG. 1) has been selected by the user, a selectable recorded program menu 202 is displayed. The selectable recorded program menu 202 is generated by the program guide application 114 of the television-based client device 102, and can be provided as an interactive on-screen menu 204. A list of recorded television programs 206 is displayed in the selectable recorded program menu 202, and the user can navigate list of recorded television programs 206 using the remote control 118, to select a program of interest from the list of recorded programs 206.

In the example shown in FIG. 2, the selectable recorded program menu 202 includes a list of recorded programs 206 that includes four different recorded television programs. These four recorded television programs are shown respectively as “Baking Bread”, “Pastry Chef”, “Outdoor Cooking”, and “Baking School” which each represents a recorded television program that is associated with a television network of interest (e.g., the “Cooking Network” 124) that was selected by the user via the interactive on-screen network menu 120 (FIG. 1).

In one implementation, each list of recorded television programs (e.g., list of recorded programs 206) includes a network logo that identifies the respective television network associated with the list of programs. In this example, the list of recorded television programs 206 includes the chef logo 208 that identifies the “Cooking Network” as being the television network associated with the list of programs 206. However, the list of recorded television programs 206 can be displayed in many different ways. For example, the list of recorded television programs 206 can be represented by text only (e.g., a written list of the program titles without an associated network logo) or by the text with an accompanying network logo (as shown in FIG. 2). The list of recorded television programs 206 can also be represented by thumbnails of the respective recorded programs.

The user can navigate the list of television programs 206 using the selectable program menu 202, and can select a particular recorded television program from the list of programs 206 using interactive on-screen controls. For example, the user can select the “Baking School” 210 from the exemplary selectable program menu 202, as shown in FIG. 2. The selection of “Baking School” 210 is indicated by the bold outline around the selected program. The selectable program menu 202 can also provide the user with various selectable controls 212 which can include “play”, “erase”, “preview”, and/or other selectable controls such as a “Play All” control which would initiate playback of all the recorded “Baking Bread” episodes, and optionally, in order. The selectable controls 212 provide a convenient way for the user to manipulate the recorded television program which has been selected.

In one implementation, and in response to a user selection of a television network from the interactive on-screen network menu 120, the program guide application 114 is configured to facilitate a display of background graphics 214 that are associated with the selected television network. For example, in FIG. 2, the user has selected the “Cooking Network” and background graphics 214 that are associated with the “Cooking Network” are displayed within the selectable program menu 202. In this example, the background graphics 214 are shown as dotted lines emanating from the text under the chef logo 208. However, a background logo may be displayed as any color, image, video, audio, graphic, and/or any combination thereof that is associated with the television network.

In one implementation, and in response to user selection of a television network via the interactive on screen network menu 120, the program guide application 114 is configured to facilitate display of an advertisement 216 that is associated with the selected television network. For example, if the “Cooking Network” is selected as described above, then advertisement 216 can be displayed. In this example, the advisement 216 encourages viewers to “Watch the Cooking Network tonight at 6:00 p.m.”. Such advertisements can be designed to promote anything associated with the selected television network. These targeted advertisements can be stored locally along with the program guide data, or the advertisements can be sent to the television-based client device 102 from the content providers 104 in response to the user's selection of a television network via the interactive on screen network menu 120.

In one implementation, and in response to user selection of a program via the selectable program menu 202, the program guide application 114 is configured to facilitate display of an advertisement 218 that is associated with the selected television program. For example, if the program “Baking School” is selected as described above, then advertisement 218 can be displayed. In this example, the advisement 218 encourages viewers to watch a “New program from the directors of Backing School”. Such advertisements can be designed to promote anything associated with the recorded television program which is selected. These targeted advertisements can also be stored locally along with the program guide data, or the advertisements can be sent to the television-based client device 102 from the content providers 104 in response to the user's selection of a recorded television program via the selectable program menu 202.

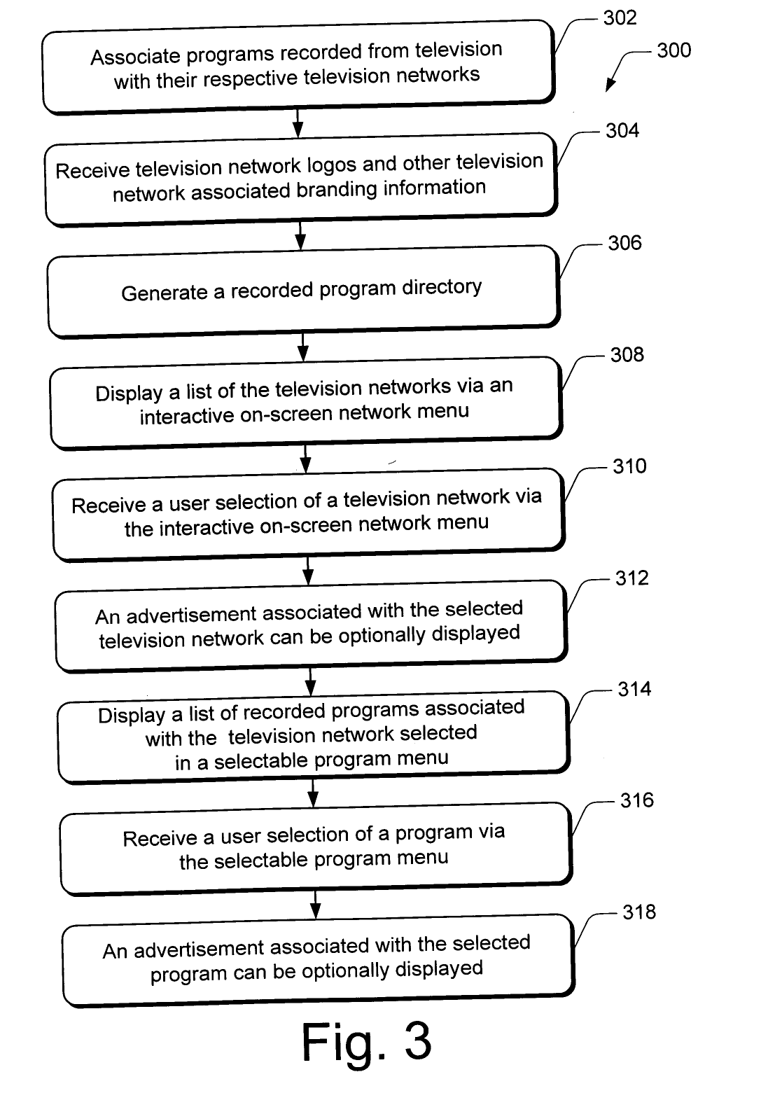

Methods for network branded recorded programs, such as exemplary method 300 described with reference to FIG. 3, may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

FIG. 3 illustrates an exemplary method 300 for network branded recorded programs, and is described with reference to the television-based systems 100 and 200 shown in respective FIGS. 1 and 2. The order in which the method is described is not intended to be construed as a limitation, and any number of the described method blocks can be combined in any order to implement the method, or an alternate method. Furthermore, the method can be implemented in any suitable hardware, software, firmware, or combination thereof.

At block 302, television network logos and other television network associated branding information is received. For example, the television network(s) logos and branding information is received from a content provider 104 and maintained in the data store 110. At block 304, programs recorded from television are associated with their respective television networks. For example, the program guide application 114 associates the list of programs 206 (e.g., “Baking Bread”, “Pastry Chef”, “Outdoor Cooking”, and “Baking School”) which have been recorded from the “Cooking Network” 124.

At block 306, a recorded program directory is generated. The program guide application generates the recorded program directory that includes the list of television networks, and further includes the list of programs recorded from television that are respectively associated with each television network in the list of television networks. For example, the program guide application 114 generates the recorded program directory that includes the list of television networks 122 (e.g., the “Cooking Network”, the “Family Network”, the “Sports Network”, the “Movie Network”, the “Music Network”, and the “Travel Network”), and the list of recorded programs 206 (e.g., “Baking Bread”, “Pastry Chef”, “Outdoor Cooking” and “Baking School”) that are associated with the “Cooking Network” 124.

At block 308, a list of networks is displayed in an interactive on-screen network menu. For example, the list of television networks 122 (e.g., the “Cooking Network”, the “Family Network”, the “Sports Network”, the “Movie Network”, the “Music Network”, and the “Travel Network”) is displayed in the interactive on-screen network menu 120.

At block 310, a user selection of a television network is received via the interactive on-screen network menu. For example, the user can select the “Cooking Network” 124 via the interactive on-screen network menu 120.

At block 312, an advertisement associated with the selected television network can be optionally displayed. For example, in response to the user selection of the “Cooking Network” 124, an advertisement 216 which is associated with the “Cooking Network” can be optionally displayed. In the example provided in FIG. 2, the advertisement 216 encourages viewers to “Watch the Cooking Network tonight at 6:00 p.m.”, thereby promoting new programming associated with the “Cooking Network” 124.

At block 314, a list of recorded programs that are associated with the television network selected by the user are displayed in a selectable program menu. For example, the list of recorded programs 206 (e.g., “Baking Bread”, “Pastry Chef”, “Outdoor Cooking”, and “Baking School”) are displayed in the selectable program menu 202.

At block 316, a user selection of a recorded television program is received via the selectable program menu. For example, the user can select the recorded program “Baking School” 210 from the list of programs 206 via the selectable program menu 202.

At block 318, an advertisement associated with the selected program can be optionally displayed. For example, in response to the user selection of the “Baking School” 210, an advertisement 218 that is associated with the recoded program “Baking School” can be optionally displayed. In the example provided in FIG. 2, the advertisement 218 encourages viewers to watch a “New program from the directors of Baking School”, thereby promoting a new program associated with the recoded program “Baking School” 210.

FIG. 4 illustrates an exemplary television-based system 400, and shows various components of an exemplary digital video recorder (DVR)-enabled client device 402 in which network branded recorded programs can be implemented. In an embodiment, client device 402 can be implemented as the television-based client device 102 described with reference to FIGS. 1-3 and shown in FIGS. 1 and 2. Additionally, client device 402 can be implemented as any one or more of the electronic, computing, and client devices described herein. For example, client device 402 can be implemented with any number of the various components as client device 102 in the television-based systems 100 or 200 shown respectively in FIGS. 1 and 2.

Client device 402 includes one or more media content inputs 404 which may include Internet Protocol (IP) inputs over which streams of media content are received via an IP-based network (such as communication network 106 shown in FIG. 1). Device 402 further includes communication interface(s) 406 which can be implemented as any one or more of a serial and/or parallel interface, a wireless interface, any type of network interface, a modem, and as any other type of communication interface. A wireless interface enables device 402 to receive control input commands 408 and other information from an input device, such as from remote control device 410, and/or from another device such as a PDA (personal digital assistant), a cellular phone, or from another infrared (IR), 802.11, Bluetooth, or similar RF input device.

A network interface provides a connection between the client device 402 and a communication network by which other electronic and computing devices can communicate data with device 402. Similarly, a serial and/or parallel interface provides for data communication directly between device 402 and the other electronic or computing devices. A modem facilitates device 402 communication with other electronic and computing devices via a conventional telephone line, a DSL connection, cable, and/or other type of connection.

Client device 402 also includes one or more processors 412 (e.g., any of microprocessors, controllers, and the like) which process various computer executable instructions to control the operation of device 402, to communicate with other electronic and computing devices, and to implement embodiments of network branded recorded programs. Device 402 can be implemented with computer readable media 414, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer readable media 414 provides data storage mechanisms to store various information and/or data such as software applications and any other types of information and data related to operational aspects of the client device 402. For example, an operating system 416 and/or other application programs 418 can be maintained as software applications with the computer readable media 414 and executed on processor(s) 412 to implement embodiments of network branded recorded programs. Further, the computer readable media 414 includes a program guide application 420 that is implemented to process program guide data 422 and generate program guides for display which enable a viewer to navigate through an onscreen display and locate broadcast programs, recorded programs, video on-demand programs and movies, interactive game selections, and other media access information or content of interest to the viewer. Still further, the computer readable media 414 includes a recorded programs application (not shown) which can be incorporated within the program guide application 420 and/or incorporated into one or more of the other application programs 418. The computer readable media 414 can also include recorded programs module 424 to maintain recorded television programs and/or other content, such as the television network logos, background images, video, graphics, and any other television network associated branding information.

The client device 402 can also include a DVR system 426 with playback application 428. The DVR system 426, along with the playback application 428, can implement the various features and aspects of network branded recorded programs, such as described in method 300 described with reference to FIG. 3.

The client device 402 also includes an audio and/or video output 430 that provides audio and video to an audio rendering and/or display system 432, or to other devices that process, display, and/or otherwise render audio, video, and display data. Video signals and audio signals can be communicated from device 402 to the audio rendering and/or display system 432 via an RF (radio frequency) link, S-video link, composite video link, component video link, analog audio connection, or other similar communication link.

FIG. 5 illustrates an exemplary entertainment and information system 500 in which an IP-based television environment can be implemented, and in which embodiments of network branded recorded programs can be implemented. System 500 facilitates the distribution of program content, program guide data, and advertising content to multiple viewers. System 500 includes a content provider 502 and television-based client systems 504(1-N) each configured for communication via an IP-based network 506.

The network 506 can be implemented as a wide area network (e.g., the Internet), an intranet, a Digital Subscriber Line (DSL) network infrastructure, or as a point-to-point coupling infrastructure. Additionally, network 506 can be implemented using any type of network topology and any network communication protocol, and can be represented or otherwise implemented as a combination of two or more networks. A digital network can include various hardwired and/or wireless links 508(1-N), routers, gateways, and so on to facilitate communication between content provider 502 and the client systems 504(1-N). The television-based client systems 504(1-N) receive program content, program guide data, advertising content, closed captions data, and the like from content server(s) of the content provider 502 via the IP-based network 506.

System 500 includes a media server 510 that receives program content from a content source 512, program guide data from a program guide source 514, and advertising content from an advertisement source 516. In an embodiment, the media server 510 represents an acquisition server that receives the audio and video program content from content source 512, an EPG server that receives the program guide data from program guide source 514, and/or an advertising management server that receives the advertising content from the advertisement source 516. The program guide data may also include the television network logos, background images, video, graphics, and any other television network associated branding information. Optionally, the television network associated information can be delivered over a different data feed to a client device.

The content source 512, the program guide source 514, and the advertisement source 516 control distribution of the program content, the program guide data, and the advertising content to the media server 510 and/or to other television-based servers. The program content, program guide data, and advertising content is distributed via various transmission media 518, such as satellite transmission, radio frequency transmission, cable transmission, and/or via any number of other transmission media. In this example, media server 510 is shown as an independent component of system 500 that communicates the program content, program guide data, and advertising content to content provider 502. In an alternate implementation, media server 510 can be implemented as a component of content provider 502.

Content provider 502 is representative of a headend service in a television-based content distribution system, for example, that provides the program content, program guide data, and advertising content to multiple subscribers (e.g., the television-based client systems 504(1-N)). The content provider 502 can be implemented as a satellite operator, a network television operator, a cable operator, and the like to control distribution of program and advertising content, such as movies, television programs, commercials, music, and other audio, video, and/or image content to the client systems 504(1-N).

Content provider 502 includes various components to facilitate media data processing and content distribution, such as a subscriber manager 520, a device monitor 522, and a content server 524. The subscriber manager 520 manages subscriber data, and the device monitor 522 monitors the client systems 504(1-N) (e.g., and the subscribers), and maintains monitored client state information.

Although the various managers, servers, and monitors of content provider 502 (to include the media server 510 in one embodiment) are illustrated and described as distributed, independent components of content provider 502, any one or more of the managers, servers, and monitors can be implemented together as a multi-functional component of content provider 502. Additionally, any one or more of the managers, servers, and monitors described with reference to system 500 can implement features and embodiments of network branded recorded programs.

The television-based client systems 504(1-N) can be implemented to include a client device 526 and a display device 528 (e.g., a television). A client device 526 of a television-based client system 504 can be implemented in any number of embodiments, such as a set-top box, a digital video recorder (DVR) and playback system, a personal video recorder (PVR), an appliance device, a gaming system, and as any other type of client device that may be implemented in a television-based entertainment and information system. In an alternate embodiment, client system 504(N) is implemented with a computing device 530 as well as a client device 526. Additionally, any of the client devices 526 of a client system 504 can implement features and embodiments of network branded recorded programs as described herein.

Although embodiments of network branded recorded programs have been described in language specific to structural features and/or methods, it is to be understood that the subject of the appended claims is not necessarily limited to the specific features or methods described. Rather, the specific features and methods are disclosed as exemplary implementations of network branded recorded programs.

1. A television based client device, comprising:
a data store configured to store programs recorded from television networks;
a program guide application configured to:
categorize each program according to an associated television network;
generate a recorded program directory that includes a list of the television networks and a list of programs associated with each of the respective television networks;
generate the list of television networks as an interactive on-screen network menu from which a user can select a television network; and
generate the list of the programs as a selectable program menu from which a user can select a program associated with the television network.

2. The television based client device of claim 1, wherein the list of television networks includes network logos that each represent a television network in the list of television networks.

3. The television based client device of claim 1, wherein each list of programs includes a network logo that identifies the respective television network associated with the list of programs.

4. The television based client device of claim 1, wherein in response to a user selection of a television network via the interactive on-screen network menu, the program guide application is further configured to facilitate display of background graphics associated with the selected television network.

5. The television based client device of claim 1, wherein in response to a user selection of a television network via the interactive on-screen network menu, the program guide application is further configured to facilitate display of an advertisement associated with the selected television network.

6. The television based client device of claim 1, wherein in response to a user selection of a program via the interactive on-screen program menu, the program guide application is further configured to facilitate display of an advertisement associated with the selected program.

7. The television based client device of claim 1, wherein the television based client device is a digital video recorder.

8. A method comprising:
associating programs recorded from television with their respective television networks; and
generating a recorded program directory that includes a list of television networks, and further includes a list of programs recorded from television that are respectively associated with each television network in the list of television networks.

9. The method of claim 8, further comprising displaying the list of television networks in an interactive on-screen network menu.

10. The method of claim 8, further comprising:
displaying the list of television networks in an interactive on-screen network menu;
receiving a user selection of a television network via the interactive on-screen network menu; and
displaying a list of the programs recorded from television that are associated with the television network selected in a selectable program menu.

11. The method of claim 8, further comprising displaying the list of television networks in an interactive on-screen network menu, the list of television networks represented by network logos that each represent a television network in the list of television networks.

12. The method of claim 8, further comprising:
displaying the list of television networks in an interactive on-screen network menu, the list of television networks represented by network logos that each represent a television network in the list of television networks;
receiving a user selection of a television network via the interactive on-screen network menu; and
displaying a list of the programs recorded from television that are associated with the television network selected in a selectable program menu, the list of programs including a network logo associating the list of programs with the television network selected.

13. The method of claim 8, further comprising:
displaying the list of television networks in an interactive on-screen network menu;
receiving a user selection of a television network via the interactive on-screen network menu; and
displaying an advertisement associated with the television network selected in response to the user selection of the television network.

14. The method of claim 8, further comprising:
displaying the list of television networks in an interactive on-screen network menu;
receiving a user selection of a television network via the interactive on-screen network menu;
displaying a list of the programs recorded from television that are associated with the television network selected in a selectable program menu;
receiving a user selection of a program from the list of programs via the selectable program menu; and
displaying an advertisement associated with the television network in response to the user selection of the program.

15. One or more computer readable media comprising computer executable instructions that, when executed, direct a digital video recording device to:
associate programs recorded from television with their respective television networks; and
generate a recorded program directory that includes a list of television networks, and further includes a list of programs recorded from television that are respectively associated with each television network in the list of television networks.

16. One or more computer readable media as recited in claim 15, further comprising computer executable instructions that, when executed, direct the digital video recording device to display the list of television networks in an interactive on-screen network menu.

17. One or more computer readable media as recited in claim 15, further comprising computer executable instructions that, when executed, direct the digital video recording device to display the list of television networks in an interactive on-screen network menu, the list of television networks displayed as network logos that each represent a television network in the list of television networks.

18. One or more computer readable media as recited in claim 15, further comprising computer executable instructions that, when executed, direct the digital video recording device to:
display the list of television networks in an interactive on-screen network menu;
receive a user selection of a television network via the interactive on-screen network menu; and
display a list of the programs recorded from television that are associated with the television network selected in a selectable program menu.

19. One or more computer readable media as recited in claim 15, further comprising computer executable instructions that, when executed, direct the digital video recording device to:
display the list of television networks in an interactive on-screen network menu, the list of television networks provided as network logos that each represent a television network in the list of television networks;
receive a user selection of a television network via the interactive on-screen network menu; and
display a list of the programs recorded from television that are associated with the television network selected, the list of programs including a network logo associating the list of programs with the television network selected.

20. One or more computer readable media as recited in claim 15, further comprising computer executable instructions that, when executed, direct the digital video recording device to:
display the list of television networks in an interactive on-screen network menu;
receive a user selection of a television network via the interactive on-screen network menu; and
display an advertisement associated with the television network selected.
